(19) United States
(12) Patent Application Publication
(10) Pub. No.: US 2021/0108618 A1
(43) Pub. Date: Apr. 15, 2021

(54) SYSTEM AND METHOD FOR DETERMINING AN OPERATING CONDITION OF A WIND TURBINE

(71) Applicant: THE AES CORPORATION, Arlington, VA (US)

(72) Inventors: Andrew BRODY, Indio, CA (US); Fred BRIGGS, Ashburn, VA (US)

(73) Assignee: THE AES CORPORATION, Arlington, VA (US)

(21) Appl. No.: 16/599,255

(22) Filed: Oct. 11, 2019

(51) Int. Cl. F03D 17/00

(52) U.S. Cl. CPC F03D 17/00; F05B 2260/80; F05B 2270/303; F05B 2270/821

(57) ABSTRACT

An exemplary system for determining an operating condition for a wind turbine having a rotor, generator, and gearbox, includes a plurality of sensors mounted within the nacelle of the wind turbine. The system also includes a pair proximity sensors are mounted adjacent to the rotor for measuring rotor displacement. A first processor is connected to receive sensor data from the pair of proximity sensors and is configured to partition the received sensor data into predefined datasets, and a second processor configured to format the predefined datasets for transmission over a network to a processing computer.

### FIELD

The present disclosure relates to determining an operating condition of a wind turbine, and particularly, determining an operating condition of a wind turbine based on sensor data measured within the nacelle.

### BACKGROUND

At wind farms or sites where one or more wind turbines are operated it is difficult to detect the condition of a wind turbine prior to a catastrophic failure occurring. The only way to detect or inspect the condition of the wind turbine is to have a technician physically inspect the structure and associated components prior to a failure occurring. These inspections normally cover the external structure of the wind turbine including the nacelle and require a technician to physically climb wind turbine structure. Performing a physical inspection also involves inspecting the inside of the nacelle. In nearly all instances, these inspections require that the wind turbine be taken offline, which results in the loss of a renewable energy resource.

### SUMMARY

An exemplary system for determining an operating condition for a wind turbine having a rotor, generator, and gearbox is disclosed, the system comprising: a plurality of sensors mounted within the nacelle of the wind turbine; a pair proximity sensors of the plurality of sensors, the pair of proximity sensors being mounted adjacent to the rotor for measuring rotor displacement; a first processor connected to receive sensor data from the pair of proximity sensors and configured to partition the received sensor data into predefined datasets; and a second processor configured to format the predefined datasets for transmission over a network to a processing computer.

A method for determining an operating condition for a wind turbine having a rotor, generator, and gearbox is disclosed, the method comprising: receiving data from a plurality of sensors mounted within the nacelle of the wind turbine, at least one pair of the plurality of sensors measuring rotor displacement; partitioning the received sensor data into predefined datasets; formatting the predefined datasets for transmission over a network; and processing the datasets to determine whether the rotor displacement is within an accepted range.

### BRIEF DESCRIPTION OF THE DRAWINGS

The scope of the present disclosure is best understood from the following detailed description of exemplary embodiments when read in conjunction with the accompanying drawings. Included in the drawings are the following figures:

FIG. 1 is a block diagram illustrating a system architecture in accordance with an exemplary embodiment of the present disclosure.

FIG. 2 is a block diagram illustrating an architecture of processing device in accordance with an exemplary embodiment of the present disclosure.

FIG. 3 is a block diagram illustrating a sensor arrangement associated with a rotor shaft in accordance with an exemplary embodiment of the present disclosure.

FIG. 4 is a block diagram illustrating a sensor arrangement associated with a generator in accordance with an exemplary embodiment of the present disclosure.

FIG. 5 is a block diagram illustrating a sensor arrangement associated with a high-speed coupling of the rotor in accordance with an exemplary embodiment of the present disclosure.

FIG. 6 is a block diagram illustrating a sensor arrangement associated with a gearbox in accordance with an exemplary embodiment of the present disclosure.

FIG. 7 is a block diagram illustrating a camera arrangement associated with a gearbox in accordance with an exemplary embodiment of the present disclosure.

FIG. 8 is a block diagram illustrating a camera arrangement associated with a high speed coupling shaft in accordance with an exemplary embodiment of the present disclosure.

FIG. 9 is a block diagram illustrating a thermal sensor arrangement associated with a main bearing and a gearbox in accordance with an exemplary embodiment of the present disclosure.

FIG. 10 is a flow diagram of a method for determining an operating condition of a wind turbine in accordance with an exemplary embodiment of the present disclosure.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

Exemplary embodiments of the present disclosure provide a manner of wind turbines to be inspected without requiring a technician to physically climb the structure of the wind turbine. The embodiments allow various types of data to be remotely collected from the turbine so that the operating status and condition of various components can be determined.

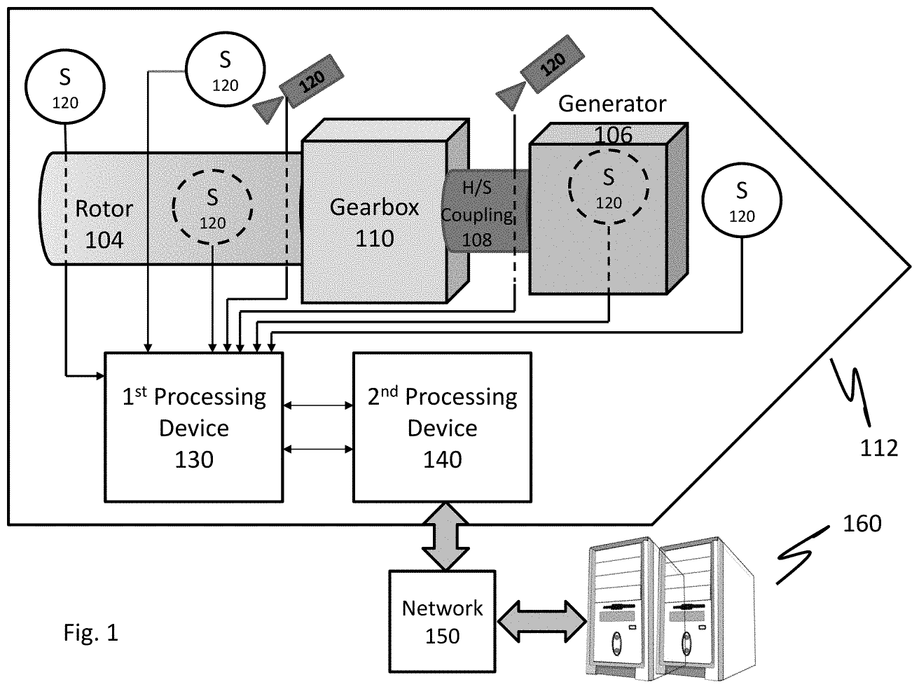

FIG. 1 is a block diagram illustrating a system architecture in accordance with an exemplary embodiment of the present disclosure.

As shown in FIG. 1, the system 100 for determining an operating condition for a wind turbine having a rotor 104, generator 106, a high speed coupling shaft 108, and a gearbox 110. The system includes a plurality of sensors 120 mounted within a nacelle 112 of the wind turbine. The sensors 120 can include one or more non-contact proximity sensors, one or more video cameras, one or more thermal cameras, one or more gas sensors, or any other suitable sensor for measuring a parameter or condition of a wind turbine component as desired. The one or more non-contact proximity sensors can include high precision and lower precision sensors. The high precision non-contact proximity sensors can measure movement in a range of approximately 0.0029 mm. The lower precision non-contact proximity sensors can measure movement in a range of approximately 0.1000 mm.

The video cameras can be configured for surveillance and monitoring the physical components within the nacelle 112 of the wind turbine. Each video camera can include an interface for connecting to a digital or communication network via a suitable Internet protocol. The video cameras can have pan, tilt, and zoom controls which can be manipulated or adjusted remotely and can be configured to capture video images in a suitable resolution, such as, 4K, high definition, standard definition, or any other suitable resolution as desired.

The one or more thermal cameras are configured to render infrared radiation as visible light using an array of detector elements. Each thermal camera can include a lens system that focuses the infrared light onto the detector array. The elements of the detector array in combination with signal processing circuitry generate a thermogram based on the received energy.

As shown in FIG. 1, a pair of proximity sensors of the plurality of sensors can be mounted adjacent to the rotor 104 for measuring rotor displacement. A first processing device 130 connected to receive sensor data from the pair of proximity sensors 110 and configured to partition the received sensor data into predefined datasets. According to an exemplary embodiment, the first processing device 130 can be configured as an interface for collecting the real-time (e.g., live-stream) data from each of the plurality of sensors. A second processing device 140 is connected to the first processing device 130 and is configured to format the predefined datasets for transmission over a network 150 to a processing server or computer 160. The second processing device 140 can be configured to receive the sensor data as the sensor data from the first processing device 130, which is configured as an interface. According to an exemplary embodiment, the operations of the first and second processing devices 130, 140 can be achieved through a single processing or computing device. The remote computing device 160 can be configured to receive predefined datasets of sensor data from the second processing device 140 and determine whether any of the rotor displacement, the high speed coupling displacement, the generator displacement, and the gearbox displacement is outside accepted ranges. For example, the remote computing device 160 can be configured as a processing server which executes any number of algorithms and/or software applications for analyzing the sensor data according to predetermined setpoints and/or ranges for determining the operating condition or status of the wind turbine and the various components as desired. The processing server 160 can be further configured to execute an application program interface (API) or other suitable graphic display for notifying a user or operator of the results of the analysis and/or determination. The API can also be configured to display or indicate the data or component under analysis and allow an operator to select one or more of the plurality of sensors for evaluating the wind turbine and/or associated component.

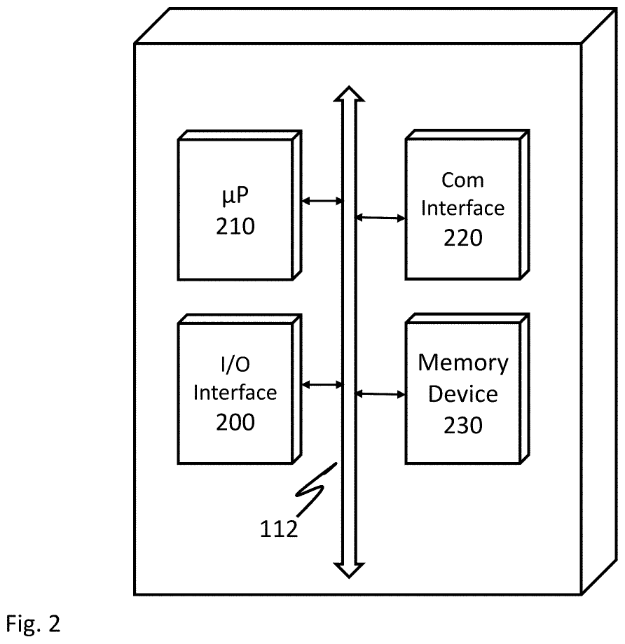

FIG. 2 is a block diagram illustrating a processing device in accordance with an exemplary embodiment of the present disclosure. As shown in FIG. 2, the computing devices 130, 140, 160 can include an input/output (I/O) interface 200, a hardware processor 210, a communication interface 220, and a memory device 230.

The I/O interface 200 can be configured to receive a signal from the hardware processor 210 and generate an output suitable for a peripheral device via a direct wired or wireless link. The I/O interface 200 can include a combination of hardware and software for example, a processor, circuit card, or any other suitable hardware device encoded with program code, software, and/or firmware for communicating with a peripheral device such as a display device, printer, audio output device, or other suitable electronic device or output type as desired.

The hardware processor 210 can be a special purpose or a general purpose processing device encoded with program code or software for performing the exemplary functions and/or features disclosed herein. The hardware processor 210 can be connected to a communications infrastructure 212 including a bus, message queue, network, multi-core message-passing scheme, for communicating with other components of the first and second processing devices 130, 140, such as the communications interface 220, the I/O interface 200, and the memory device 230. The hardware processor 210 can include one or more processing devices such as a microprocessor, central processing unit, microcomputer, programmable logic unit or any other suitable hardware processing devices as desired.

The communications interface 220 can include a combination of hardware and software components and be configured to receive data from the plurality of sensor devices 120. The communications interface 220 can include a hardware component such as an antenna, a network interface (e.g., an Ethernet card), a communications port, a PCMCIA slot and card, or any other suitable component or device as desired. The communications interface 220 can be encoded with software or program code for receiving signals and/or data packets encoded with sensor data from another device, such as a database, image sensor, image processor or other suitable device as desired. The communication interface 220 can be connected to the plurality of sensor devices via a wired or wireless network or via a direct wired or wireless link. The hardware and software components of the communication interface 220 can be configured to receive the sensor data according to one or more communication protocols and data formats. For example, the communications interface 220 can be configured to communicate over a network 150, which may include a local area network (LAN), a wide area network (WAN), a wireless network (e.g., Wi-Fi), a mobile communication network, a satellite network, the Internet, fiber optic, coaxial cable, infrared, radio frequency (RF), Modbus, I2C, or any combination thereof.

The communication interface 220 can be configured to receive the sensor data as a live data stream from one or more of the plurality of sensors. According to an exemplary embodiment, the sensor data can also be obtained as recorded or stored data from a database or memory device. During a receive operation, the receiving unit 110 can be configured to identify parts of the received data via a header and parse the data signal and/or data packet into small frames (e.g., bytes, words) or segments for further processing at the hardware processor 210.

According to an exemplary embodiment, the communications interface 220 can be configured to receive data from the processor 210 and assemble the data into a data signal and/or data packets according to the specified communication protocol and data format of a peripheral device or remote device to which the data is to be sent. The communications interface 220 can include any one or more of hardware and software components for generating and communicating the data signal over the network 150 and/or via a direct wired or wireless link to a peripheral or remote device.

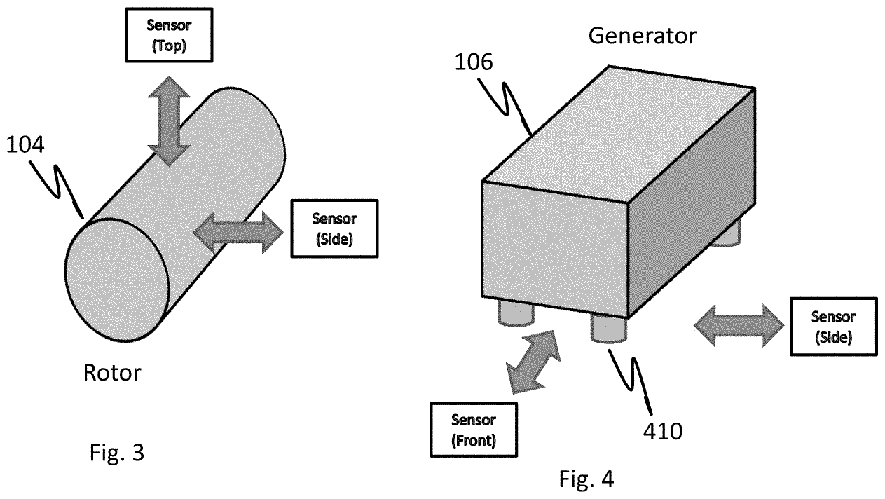

As already discussed, the system can include a plurality of sensor devices 120 that are arranged in various locations in the nacelle 112. FIG. 3 is a block diagram illustrating a sensor arrangement associated with a rotor in accordance with an exemplary embodiment of the present disclosure. As shown in FIG. 3, the sensors can be non-contact proximity sensors that monitor rotor displacement in two directions. For example, one sensor in the pair of non-contact proximity sensors can be positioned to monitor a balance property of the rotor 104 from a top position, and the other sensor in the pair can be positioned at a side position relative to the rotor 104.

FIG. 4 is a block diagram illustrating a sensor arrangement associated with a generator in accordance with an exemplary embodiment of the present disclosure. As shown in FIG. 4, the plurality of sensors includes a pair of non-contact proximity sensors mounted adjacent to the generator 106 for measuring generator displacement. For example, one sensor in the pair of non-contact proximity sensors can be disposed in a front position relative to the generator 106 and the other sensor can be positioned at a side position relative to the generator 106. The non-contact proximity sensors of FIG. 4 can be disposed to monitor or detect forward, backward, and side movement of a foot 410 of the generator 106.

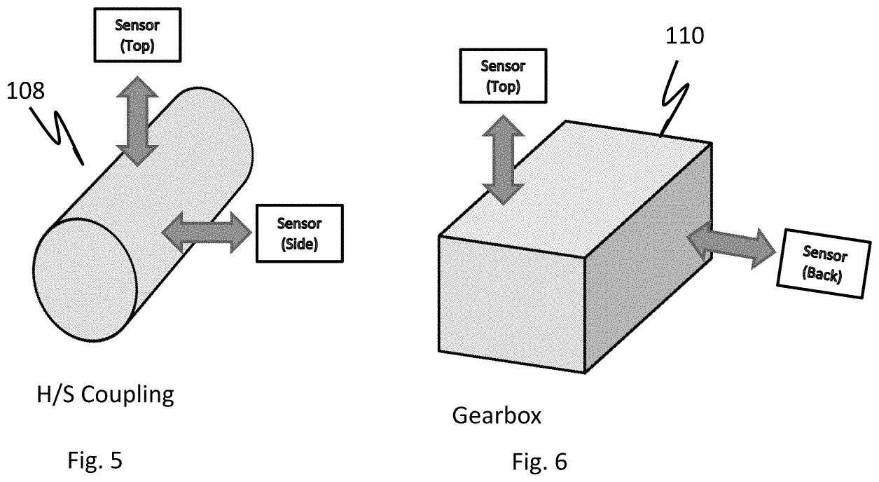

FIG. 5 is a block diagram illustrating a sensor arrangement associated with a high speed coupling shaft in accordance with an exemplary embodiment of the present disclosure. As shown in FIG. 5, the sensor arrangement includes a pair of non-contact proximity sensors arranged proximal to the high speed coupling shaft 108 of the rotor 104 and generator 106. The pair of non-contact proximity sensors includes one sensor arranged in a top position relative to the high speed coupling shaft 110 and a side position.

FIG. 6 is a block diagram illustrating a sensor arrangement associated with a gearbox in accordance with an exemplary embodiment of the present disclosure. As shown in FIG. 6, the plurality of sensors includes a pair of non-contact proximity sensors mounted adjacent to the gearbox 110 for measuring gearbox displacement. The pair of non-contact proximity sensors positioned to monitor forward, backward, up, and down movement of the gearbox 110. According to an exemplary embodiment of the present disclosure, one sensor in the pair can be positioned in proximity to a torque arm of the gearbox 110 to measure up and down movement. Another one of the pair of sensors can be focused on the body of the gearbox 110 to measure forward and backward movement.

As already discussed the plurality of sensors can include video cameras to provide visual monitoring and surveillance within the nacelle 112 for observing movement and/or vibration in various components of the wind turbine.

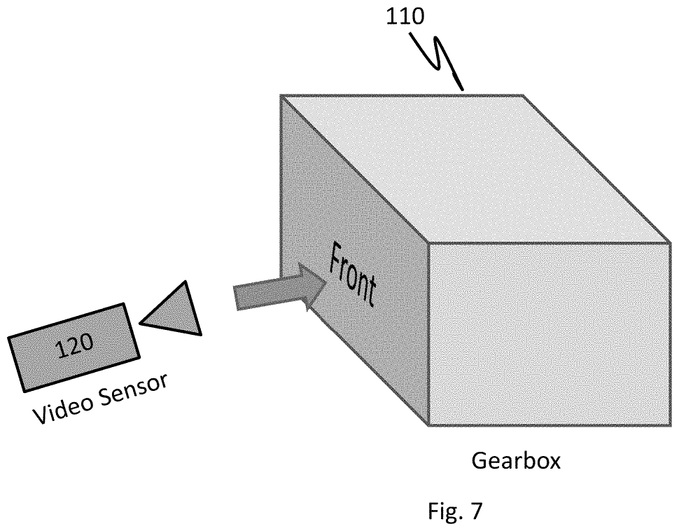

FIG. 7 is a block diagram illustrating a camera arrangement associated with a gearbox in accordance with an exemplary embodiment of the present disclosure. As shown in FIG. 7, the camera is positioned to look at a front side of the gearbox 110 during operation.

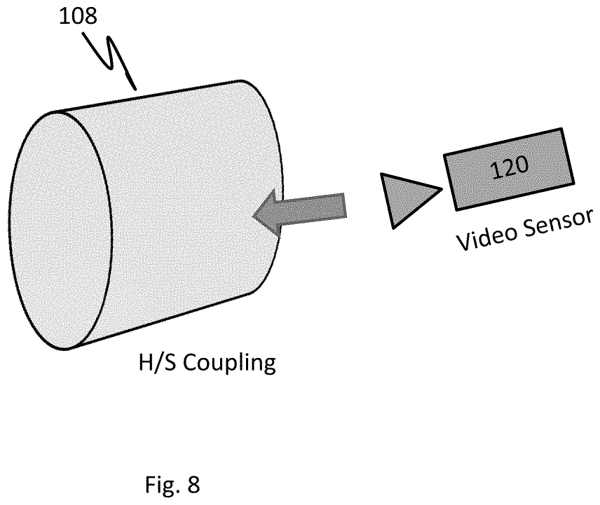

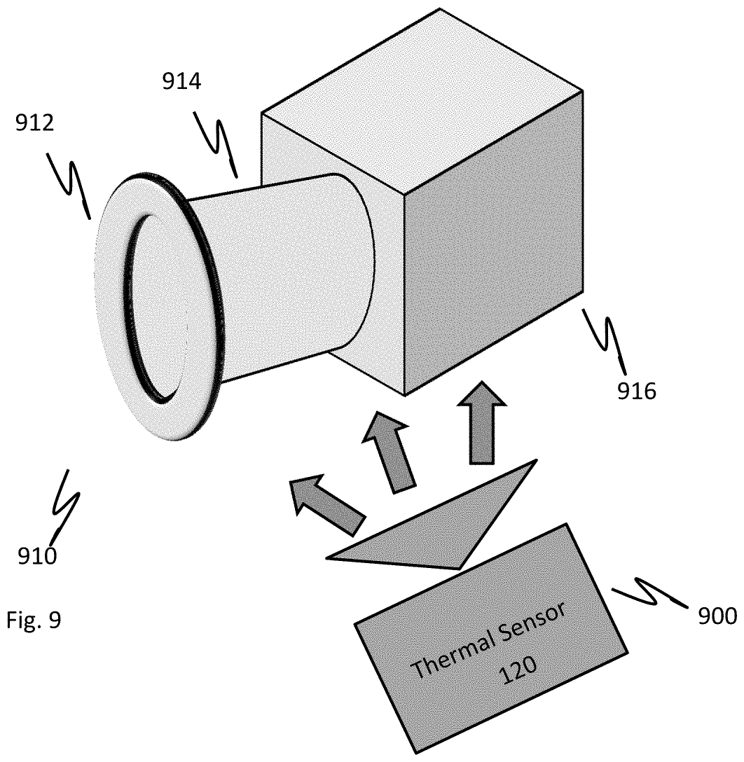

FIG. 8 is a block diagram illustrating a camera arrangement associated with a high speed coupling shaft in accordance with an exemplary embodiment of the present disclosure. As shown in FIG. 8, one or more sensors can be mounted adjacent to couplings connecting the gearbox 110 and the generator 106. The sensor can include a camera disposed to have a side vantage point of the high speed coupling shaft 108 for measuring displacement. This camera provides video data and a vantage point of the gearbox 110 which allows movement and/or vibration to be visually observed. The video cameras of FIGS. 7 and 8 can be configured to receive power over an Ethernet connection and communicate data over the Ethernet connection to the first processing device using a secure IP protocol.

FIG. 9 is a block diagram illustrating a thermal sensor arrangement associated with a main shaft assembly in accordance with an exemplary embodiment of the present disclosure. As shown in FIG. 9, the senor arrangement includes a thermal sensor 900 that is positioned to detect thermal radiation from the main shaft assembly 910. The main shaft assembly 910 includes a main bearing 912, a main shaft 914, and a gearbox 916.

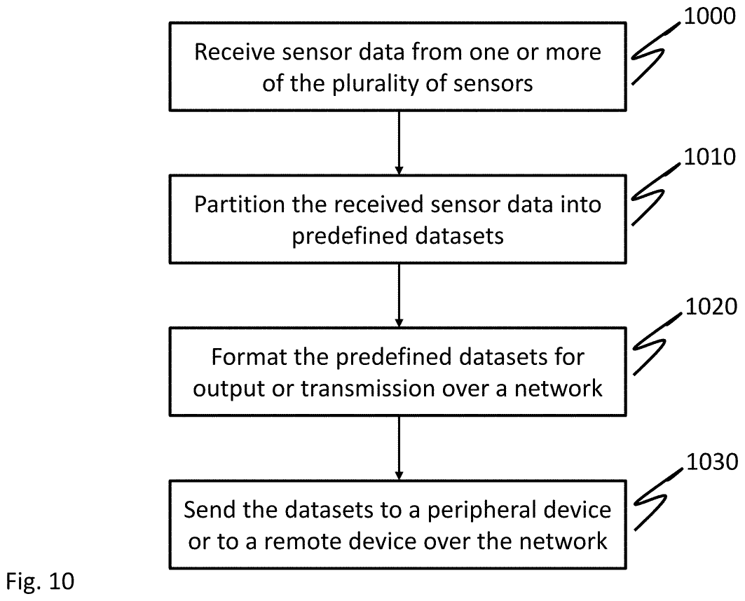

FIG. 10 is a flow diagram of a method for determining an operating condition of a wind turbine in accordance with an exemplary embodiment of the present disclosure. In step 1000, the first processing device receives data from one or more of the plurality of sensors mounted within the nacelle 112 of the wind turbine. The received data is associated with one or more of rotor displacement, gearbox displacement, coupling displacement for a high speed coupling shaft 108 between the gearbox 110 and the generator 106, generator displacement, and a temperature of the main shaft assembly via a thermal image. The first processing device 130 partitions the received sensor data into predefined datasets (step 1010) and formats the predefined datasets for transmission over a network (step 1020). For example, the first processing device 130 can receive raw sensor data including measurement data and generate a header, which identifies the sensor from which the data originated. The first processing device 130 can assemble the header and measurement data according to a specified data format or protocol. According to an exemplary embodiment, the header and measurement data can be formatted into a comma delimited string with a termination character. For example, if the received sensor data originated from a sensor reading measurements associated with the high speed coupling shaft 108, the data can be formatted as follows:
“HIGHSPEED,100,120,110,120,150,92,133,!”

The header “HIGHSPEED” indicates the measurement data is from the high speed coupling shaft 108. The header is followed by the measurement data in which measurements for specified time readings are delimited by commas. The character “!”, which follows the measurement data, is a terminating character indicating the end of the dataset. It should be understood that the dataset can include one or more additional data elements according to the specified protocol for communication and/or analysis.

The first processing device 130 sends the formatted datasets to the second processing device 140 for analysis. The second processing device 140 processes the datasets to determine whether the rotor displacement is within an accepted range. According to an exemplary embodiment, the second processing device 140 can execute any of a number of algorithms to analyze the received datasets and determine whether the measurement data indicates that any of the rotor 104, gearbox 110, generator 106, and/or high speed coupling shaft 108 is or has experienced displacement which is outside of accepted tolerances.

According to another exemplary embodiment, when the received sensor data includes video data, the second processing device 140 can be configured to execute image recognition and/or image analysis software for determining an operating condition of the monitored component in the image. For example, via image analysis, the second processing device 140 can be configured to determine a significance of any vibrations and/or movement in the monitored component. Moreover, the image analysis can recognize any defects or deterioration in the monitored component, such as cracks, deformities, leaks, or any other suitable deficiency in the monitored component as desired.

According to yet another exemplary embodiment, when the received sensor data includes audio data, the second processing device 140 can be configured to execute audio recognition and/or audio analysis software for determining an operating condition of the monitored component. For example, the second processing device 140 can be configured to analyze the sound patterns and determine whether any of the patterns indicate an adverse, defective, or deteriorating operating condition with respect to the monitored component when compared to baseline sound patterns.

According to an exemplary embodiment of the present disclosure, when the received sensor data includes thermal imaging data, the second processing device 140 can be configured to execute thermal analysis software for determining whether the thermal profile of the monitored component is outside of an accepted range or tolerance. Furthermore, the second processing device 140 can be configured to generate a graphic display and/or graphic representation of the thermal profile of the monitored component. According to an exemplary embodiment, the graphic display can identify specified areas or portions of the monitored component which are within and/or outside of the accepted temperature range and/or those areas that may be under increased stress.

The computer program code for performing the specialized functions described herein can be stored on a medium and computer usable medium, which may refer to memories, such as the memory devices for the first and second computing device 130, 140 and the remote computing device 160, which may be memory semiconductors (e.g., DRAMs, etc.). These computer program products may be a tangible non-transitory means for providing software to the computing devices 130, 140, and 160 disclosed herein. The computer programs (e.g., computer control logic) or software may be stored in a resident memory device 230 and/or may also be received via the communications interface 220. Such computer programs, when executed, may enable the associated computing devices and/or server to implement the present methods and exemplary embodiments discussed herein and may represent controllers of the computing device 130, 140, 160. Where the present disclosure is implemented using software, the software may be stored in a computer program product or non-transitory computer readable medium and loaded into the corresponding device 130, 140, 160 using a removable storage drive, an I/O interface 200, a hard disk drive, or communications interface 220, where applicable.

The hardware processor 210 of the computing device 100 can include one or more modules or engines configured to perform the functions of the exemplary embodiments described herein. Each of the modules or engines may be implemented using hardware and, in some instances, may also utilize software, such as corresponding to program code and/or programs stored in memory 230. In such instances, program code may be compiled by the respective processors (e.g., by a compiling module or engine) prior to execution. For example, the program code may be source code written in a programming language that is translated into a lower level language, such as assembly language or machine code, for execution by the one or more processors and/or any additional hardware components. The process of compiling may include the use of lexical analysis, preprocessing, parsing, semantic analysis, syntax-directed translation, code generation, code optimization, and any other techniques that may be suitable for translation of program code into a lower level language suitable for controlling the computing device 130, 140, 160 to perform the functions disclosed herein. According to an exemplary embodiment, the program code can be configured to execute a neural network architecture, or machine learning algorithm wherein the image, sound, and/or thermal analysis operations can be performed according to corresponding training vectors and the neural network can learn further patterns and/or features identifying an operating condition or event from each subsequent analysis. It will be apparent to persons having skill in the relevant art that such processes result in the computing device 130, 140, 160 being a specially configured computing devices uniquely programmed to perform the functions discussed above.

While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A system for determining an operating condition for a wind turbine having a rotor, generator, and gearbox, the system comprising:
a plurality of sensors mounted within the nacelle of the wind turbine;
a pair proximity sensors of the plurality of sensors, the pair of proximity sensors being mounted adjacent to the rotor for measuring rotor displacement;
a first processor connected to receive sensor data from the pair of proximity sensors and configured to partition the received sensor data into predefined datasets; and
a second processor configured to format the predefined datasets for transmission over a network to a processing computer.

2. The system of claim 1, wherein the plurality of sensors includes a pair of non-contact proximity sensors mounted adjacent to the generator for measuring generator displacement.

3. The system of claim 1, wherein the plurality of sensors includes a pair of non-contact proximity sensors mounted adjacent to couplings connecting the gearbox and the generator for measuring coupling displacement.

4. The system of claim 1, wherein the plurality of sensors includes a pair of non-contact proximity sensors mounted adjacent to the gearbox for measuring gearbox displacement.

5. The system of claim 1, wherein the pair of proximity sensors mounted adjacent to the rotor are non-contact proximity sensors that monitor rotor displacement in two directions.

6. The system of claim 1, wherein the pair of proximity sensors include a first sensor mounted in a top position relative to the rotor and a second sensor mounted in a side position relative to the rotor.

7. The system of claim 1, wherein the plurality of sensors includes a thermal camera mounted to have a drivetrain of the wind turbine in a field of view.

8. The system of claim 7, wherein the field of view includes a main shaft of the rotor and the gearbox.

9. The system of claim 8, wherein the thermal camera monitors temperature in a plurality of locations on the drivetrain.

10. The system of claim 1, further comprising:
an interface for collecting the real-time data from each of the plurality of sensors, wherein the first processor is configured to receive the real-time data as the sensor data from the interface.

11. The system of claim 1, further comprising:
at least one camera configured to receive power over an Ethernet connection and communicate data over the Ethernet connection, wherein the data is transmitted to a remote processor using a secure IP protocol.

12. A computing device connected in combination with the system of claim 1, the computing device comprising:
a third processor configured to receive the predefined datasets of sensor data from the second processor and determine whether any of the rotor displacement, the coupling displacement, the generator displacement, and the gearbox displacement is outside accepted ranges.

13. A method for determining an operating condition for a wind turbine having a rotor, generator, and gearbox, the method comprising:
receiving data from a plurality of sensors mounted within the nacelle of the wind turbine, at least one pair of the plurality of sensors measuring rotor displacement;
partitioning the received sensor data into predefined datasets;
formatting the predefined datasets for transmission over a network; and
processing the datasets to determine whether the rotor displacement is within an accepted range.

14. The method of claim 13, comprising:
mounting the at least one pair of the plurality of sensors for measuring rotor displacement in two directions.

15. The method of claim 13, comprising:
receiving data from a second pair of the plurality of sensors adjacent the gearbox for measuring gearbox displacement.

16. The method of claim 15, comprising:
receiving data from a third pair of the plurality of sensors adjacent a coupling between the gearbox and the generator for measuring coupling displacement.

17. The method of claim 16, comprising:
receiving data from a fourth pair of the plurality of sensors adjacent the generator for measuring generator displacement.

18. The method of claim 17, comprising:
receiving data from a thermal camera of the plurality of sensors for measuring a temperature of the drivetrain in a plurality of locations.
